(19) United States
(12) Patent Application Publication
(10) Pub. No.: US 2004/0111642 A1
(43) Pub. Date: Jun. 10, 2004

(54) Content security by network switch

(76) Inventor: Amir Peles, Tel Aviv (IL)

Correspondence Address: KATTEN MUCHIN ZAVIS ROSENMAN, 575 MADISON AVENUE, NEW YORK, NY, 10022-2585, US

(21) Appl. No.: 10/713,684

(22) Filed: Nov. 14, 2003

Related U.S. Application Data
(60) Provisional application No. 60/431,172, filed on Dec. 5, 2002.

(51) Int. Cl. G06F 11/30; G06F 15/173

(52) U.S. Cl. 713/201; 709/223; 717/143

(57) ABSTRACT

A security switch detects whether requested content is either trusted content or non-trusted content. In case of network content being trusted content, network traffic bypasses the inspection gateway and goes directly to the user. If network content is non-trusted content, network traffic passes through to the inspection gateways for inspection. Additionally, when the security switch receives a reply for “trusted” content requests, it parses the reply information to verify that the content-type of the file is indeed “trusted”. If the file doesn't prove to be “trusted”, the security switch drops the connection and stops the suspected content from reaching the client.

### BACKGROUND OF THE INVENTION

1. Field of Invention

The present invention relates generally to the field of security. More specifically, the present invention is related to a security switch implementing content security.

2. Discussion of Prior Art

Security has become a major concern in networks such as the Internet. Network security is usually compromised by malicious attacks directed at such networks. Such attacks can be classified into two major categories. The first category comprises attacks directed towards a network. For example, this type of attack would include sending false commands or bombarding a network with more traffic than it can handle. Attacks in this category usually result in the failure of network hardware, such as servers, firewalls, personal computers, and networking equipment. The second category comprises attacks directed towards applications. For example, this type of attack would include encapsulating viruses within applications and tampering with the file system, operating system, or databases. Attacks in this category usually result in severe problems in servers and personal computers.

A myriad of solutions exist for protecting servers and PCs from attacks of the second category. One popular solution involves the use of antivirus and application-firewall products, which protect a network by inspecting all incoming/outgoing communication. If the content of an incoming request doesn't fit a well-defined format, or if the content of an outgoing reply contains suspicious patterns, these products will drop or isolate the malicious traffic. Such solutions ensure, to a good degree, the safety of clients and servers.

Content traversing the Internet can generally be classified into two major types: “trusted” and “non-trusted”. Trusted content comprises data such as images, audio streams, and video streams. Trusted content seldom causes any harm to clients/servers as their format is very specific and such content is usually sent for simply being presented to the end-user. Hence, any tampering with such content affects information being rendered at the user's end, but does not affect computers and network equipment.

Non-trusted content comprises meta-data (associated with applications) like scripts, markup languages, and active objects that guide an application in deciding which data should be presented to the user and which activities should be invoked on the computer. Tampering with non-trusted content can generate unexpected behavior in a user's computer, which usually results in either damage to the computer or security being compromised by making content stored in the computer vulnerable to access by unauthorized users.

Prior art in the field of security involves separating network security, provided by the networking equipment, and application security, provided by special inspection gateways. The networking equipment classifies the traffic according to its source/destination and application type (associated with the traffic). Traffic that belongs to users or applications that require content protection is forwarded to the inspection gateways for verification. Other traffic is just forwarded to its destination.

The inspection gateways verify, for “trusted” and “non-trusted” content, every request/reply that passes. This operation is slow and consumes a lot of resources. So, in most practical scenarios, such content inspection is limited and/or expensive. The references provided below provide for a general description in the area of security.

The patent application publication to Jungck et al. (Ser. No. 2002/0,009,079 A1) provides for an edge adapter apparatus and method. Disclosed is a packet interceptor/processor apparatus that is coupled with a network in order to be able to intercept and process packets flowing over the network. Further, the apparatus provides external connectivity to other devices that wish to intercept packets as well. The apparatus applies one or more rules to the intercepted packets which execute one or more functions on a dynamically specified portion of the packet and take one or more actions with the packets. The apparatus is capable of analyzing any portion of the packet including the header and payload. Actions include releasing the packet unmodified, deleting the packet, modifying the packet, logging/storing information about the packet or forwarding the packet to an external device for subsequent processing. Further, the rules may be dynamically modified by the external devices.

The patent application publication to Canion et al. (Ser. No. 2002/0,108,059 A1) provides for a network security accelerator. The security hardware performs initial processing of incoming data, such as security detection tasks. The security hardware is directly connected to one or more processing units, via a bus or switch fabric, which execute appropriate applications and/or storage programming.

The patent application publication to Smith (Ser. No. 2002/0,152,399 A1) provides for a system and method for providing exploit protection for networks. The system and method include a component for determining whether an encapsulation has been applied to an attachment and unencapsulating such encapsulated attachments; a component for decompressing attachments when the attachment is compressed; a component for determining whether a header, body, and/or attachment of a message includes an exploit; and a component for holding and optionally cleaning messages that include exploits. A device that receives messages that are directed to the network employs the components above to provide exploit protection for at least one of the messages.

The patent application publication to Hong et al. (Ser. No. 2002/0,073,232 A1) provides for non-intrusive multiplexed transaction persistency in secure commerce environments. Disclosed is a network switch that determines when specific content is “hot” and directs flow to one or more cache servers. The disclosed architecture provides for a decryption processor for authenticating clients and decrypting and encrypting transaction requests before the transaction requests are routed by the switch.

The patent to Colby et al. (U.S. Pat. No. 6,449,647 B1), assigned to Cisco Systems, Inc., provides for a content-aware flow switch intercepting a client content request in an IP network and transparently directing the content request to a best-fit server. The best-fit server is chosen based on the type of content requested, the quality of service requirements implied by the content request, the degree of load on available servers, network congestion information, and the proximity of the client to available servers. The flow switch detects client-server flows based on the arrival of TCP SYNs and/or HTTP GETs from the client. The flow switch implicitly deduces the quality of service requirements of a flow based on the content of the flow. The flow switch also provides the functionality of multiple physical web servers on a single web server in a way that is transparent to the client, through the use of virtual web hosts and flow pipes.

Whatever the precise merits, features, and advantages of the above cited references, none of them achieves or fulfills the purposes of the present invention.

### SUMMARY OF THE INVENTION

The present invention provides for a system and a method for implementing a network security level using a security switch, wherein the security switch stores a modifiable list of trusted file extensions and a modifiable list of trusted content types. The method, as implemented in the network switch, includes the steps of:

(a) receiving a request from a client for establishing a communication session with a server;

(b) parsing and identifying a file extension associated with the received request;

(c) comparing the identified file extension with the pre-stored list of trusted file extensions;

(d) upon not finding a successful match, forwarding the received request to an inspection gateway; else

(e) establishing a communication session with the server and forwarding the received request to the server;

(f) receiving a reply from the server corresponding to the received request, containing an object;

(g) parsing the reply to identify a content-type of the object;

(h) comparing the identified content-type with the pre-stored list of trusted content-types; and

(i) upon finding a successful match, forwarding the reply to the client.

The present invention's system implementing network security for content exchanged between a client and a server over a network includes:

a security switch storing a modifiable list of trusted file extensions; the security switch receives and parses requests to identify a file extension associated with a received request, compares the identified file extension with the pre-stored list of trusted file extensions, and, upon finding a successful match, establishes a communication session with the server and forwards the received request to the server, and receives a reply from the server with an object related to the received request; and

an inspection gateway working in conjunction with the security switch and receives forwarded requests when a file extension of a request fails to match trusted file extensions in the pre-stored list; the inspection gateway communicates with the server and retrieves, inspects, and verifies an object related to the received request, and, based upon successful verification, forwards a reply with the object to the security switch or directly to the client.

In an extended embodiment, the security switch further includes a modifiable list of trusted content-types, and the security switch, after reception of said reply from the server, parses the reply to identify a content-type of said object, compares the identified content-type with the pre-stored list of trusted content-types, and upon finding a successful match, forwards the reply to the client.

In an extended embodiment, the security switch further receives said reply from the inspection gateway, and forwards the reply to the client.

In yet another embodiment, the abovementioned operations associated with the security switch of the present invention are limited to a selected list of clients and/or a selected list of servers. Hence, a request is parsed to see if the request comes from a selected client to a selected server, prior to executing the abovementioned operations associated with the security switch.

All through the specification, “file extensions” have been used as the identifier to distinguish between trusted and non-trusted requests. However, it should be noted that other identifiers may also be in the request, and the use of any such identifier to determine whether the request is trusted or non-trusted is equivalent to using the “file extension” identifier.

Similarly, the specification describes the use of the “Content-Type” field as the identifier for differentiating if the reply is trusted or non-trusted. It should be noted that other identifiers may also be in the reply, and the use of such identifiers to determine whether the reply is trusted or non-trusted is equivalent to the use of the above-mentioned “Content-Type” field.

### BRIEF DESCRIPTION OF THE DRAWINGS

FIG. 1 illustrates a general setup using the present invention's security switch.

FIG. 2 illustrates how the present invention's security switch parses a request, such as an HTTP request.

FIG. 3 illustrates the instance wherein a request is associated with “non-trusted” content.

FIG. 4 illustrates the instance wherein a request is associated with “trusted” content.

FIG. 5 illustrates a scenario outlining the methodology implemented by the security switch in parsing a server reply.

FIG. 6 illustrates how “trusted” traffic is forwarded back to the client.

FIG. 7 illustrates a scenario wherein the reply is deemed “non-trusted”.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention's system and method provides for a new network security level that takes into account not only the user and the application, but also the type of content. The security switch of the present invention detects whether the requested content is a trusted content or a non-trusted content. In the case of network content being trusted content, network traffic bypasses the inspection gateway and goes directly between the user and the server. Only non-trusted traffic passes through to the inspection gateway for verification of the content. Advantages of the novel network security level include (but are not limited to) faster response time to the user and less expensive inspection gateways. Such benefits are attained without compromising the security level, while still maintaining support for higher bandwidth network traffic.

The present invention's security switch may be situated in the middle of the network. The security switch may be implemented as a stand-alone processing device, including hardware (such as a CPU, memory, storage and peripheral hardware such as co-processing) and/or software. Further, the security switch may be implemented in conjunction with other network equipment such as a network switch, firewall or load balancers. It should be noted that the examples shown in the attached drawings are for illustrative purposes and do not limit the implementations of the security switch. The security switch can manage requests and replies of multiple clients, servers and inspection gateways.

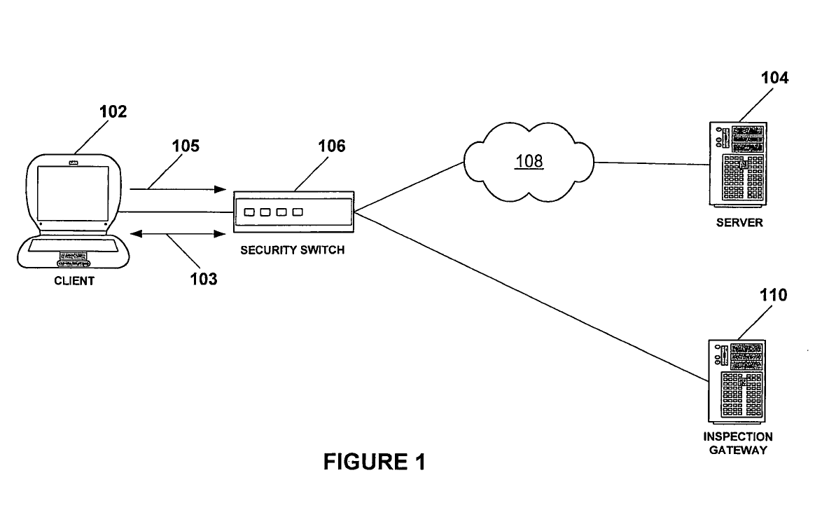

As shown in FIG. 1, client 102 makes a request to open a TCP session with server 104. Security switch 106 that is located between client 102 and network 108 receives the request and accepts the connection in lieu of server 104. Security switch 106 is able to communicate with server 104 (over network 108) and an inspection gateway 110 (e.g., an antivirus gateway). Client 102 completes the TCP handshake 103 and sends its request for data 105.

Examples of network 108 include (but are not limited to) a local area network (LAN), a wide area network (WAN), a metropolitan area network (MAN), a wireless network, a cellular network, or combinations thereof. Although only one network cloud 108 is shown in FIG. 1 to represent a link between security switch 106 and server 104, it should be noted that the system and method of the present invention can work in conjunction with a plurality of networks.

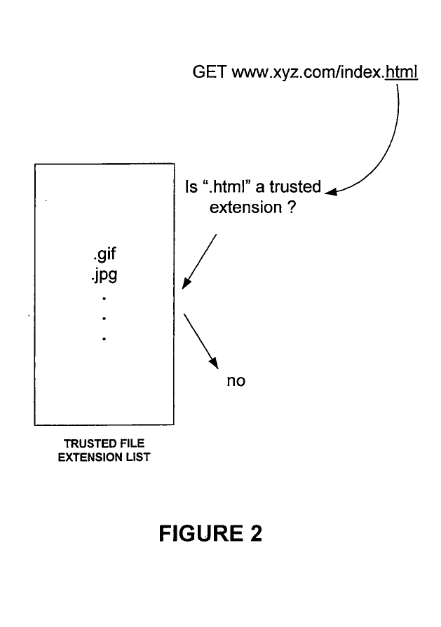

FIG. 2 illustrates how the present invention's security switch (106 of FIG. 1) parses a request such as an HTTP request. The security switch identifies the type of content by parsing requests. Each request contains a file identifier, and each file has an associated name and extension. The extensions are well-known and provide an indication as to the type of file. For example, “gif”, “bmp”, “jpg” are image file extensions, while “wav”, “mp3” are audio file extensions. The security switch recognizes the extension and checks the extension against a list of pre-defined “trusted” extension names. If the extension doesn't appear in the list maintained by the security switch, the content is regarded as “non-trusted”. On the other hand, if the file extension matches an extension maintained in the list, the content is regarded as “trusted”.

In the specific example of FIG. 2, the security switch parses an incoming request and identifies the file name extension (i.e., HTML). Next, the security switch verifies if the “HTML” extension is a trusted extension by comparing it against a maintained list of trusted extensions. After determining the file extension and whether it falls into the “trusted” or “non-trusted” file extension, the security switch decides the traversal path of the request. For example, the security switch decides whether the request should go directly to the server or go through an inspection gateway. Specifically, the security switch sends non-trusted content to an inspection gateway (such as gateway 110 of FIG. 1) and trusted content is sent to the server (e.g., an Internet server). Based upon the decision made, the security switch opens a TCP connection in the name of the client with the server or inspection gateway, and passes the request forward.

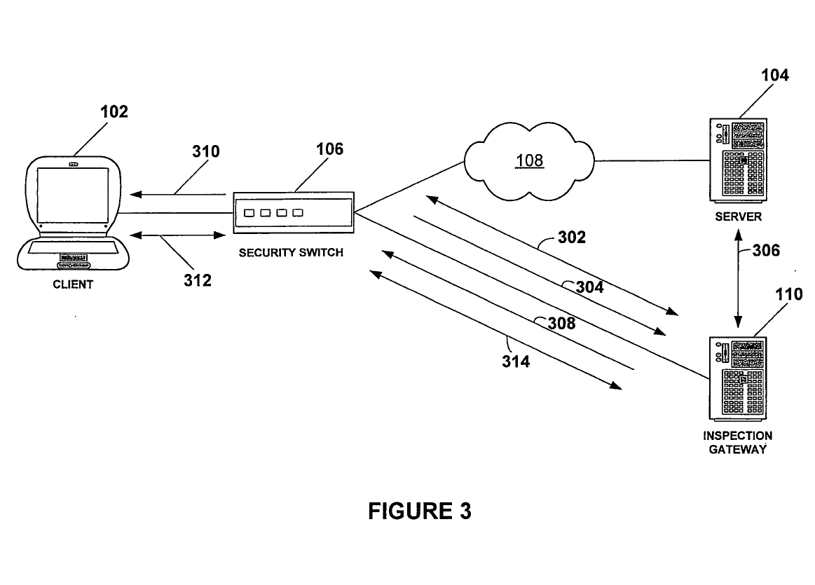

FIG. 3 illustrates the instance wherein a request is associated with “non-trusted” content. First, in step 302, security switch 106 opens a TCP connection in the name of the client with the inspection gateway 110. Next, in step 304, security switch 106 sends an HTTP request to inspection gateway 110. Then, in step 306, inspection gateway 110 retrieves requested object for inspection from server 104, and in step 308, inspection gateway 110 sends a reply to security switch 106 after inspection is complete. In step 310, security switch 106 forwards the reply to client 102. Next, connections to client 102 and inspection gateway 110 are closed in steps 312 and 314 respectively.

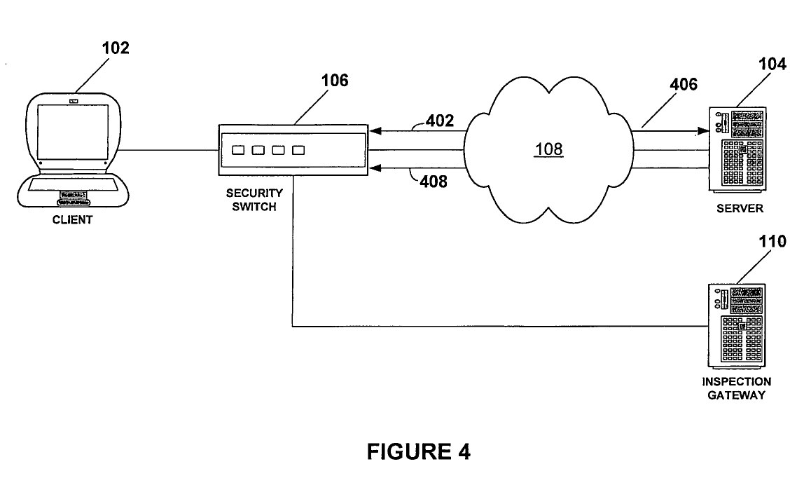

FIG. 4 illustrates the instance wherein a request is associated with “trusted” content. First, in step 402, security switch 106 opens a TCP connection in the name of client 102 with server 104; and in step 406, security switch 106 sends an HTTP request to server 104 over network 108. Then, the server, in step 408, sends an HTTP reply to security switch 106.

It should be noted that the file extension is only an indicator to the content type, and the actual content type can only be determined by a content-type field that is part of the reply. For example, “image/gif” and “image/jpeg” are associated with image files. This field is the actual descriptor of the file and is the parameter that determines the action that the client computer does with the content. Non-standard implementers can use unknown extension names or worse, they can use known extension names of “trusted” content for “non-trusted” content.

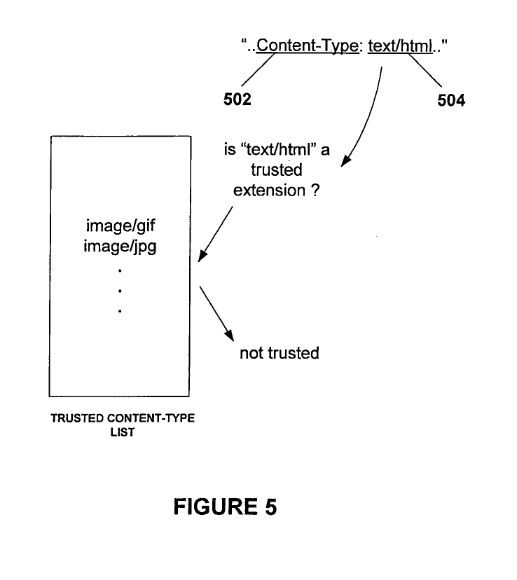

When a security switch receives the reply for “trusted” content requests from the server, the security switch parses the reply information to verify that the content-type of the file is indeed “trusted”. If the file doesn't prove to be “trusted”, the security switch drops the connection and stops the suspected content from the client. This is illustrated in FIGS. 5, 6, and 7.

FIG. 5 illustrates a scenario outlining the methodology implemented by the security switch in parsing an Internet server reply. First, the content-type field 502 is located in the reply, and the actual content type 504 is identified (e.g., text/html). Next, the content-type is compared against a list of trusted content-types (stored at the security switch 106). If a match is found in the stored list, the trusted content is forwarded to the client. If a match is not found in the stored list, the non-trusted content is discarded. In the specific example of FIG. 5, “text/html” 504 is compared against the list in the security switch 106, and, since a match is not found, the security switch determines that the content is non-trusted content and discards it. Optionally, the user/administrator is informed about the suspected content and the content is secured/isolated. Further, precautions are taken for future requests for the same content.

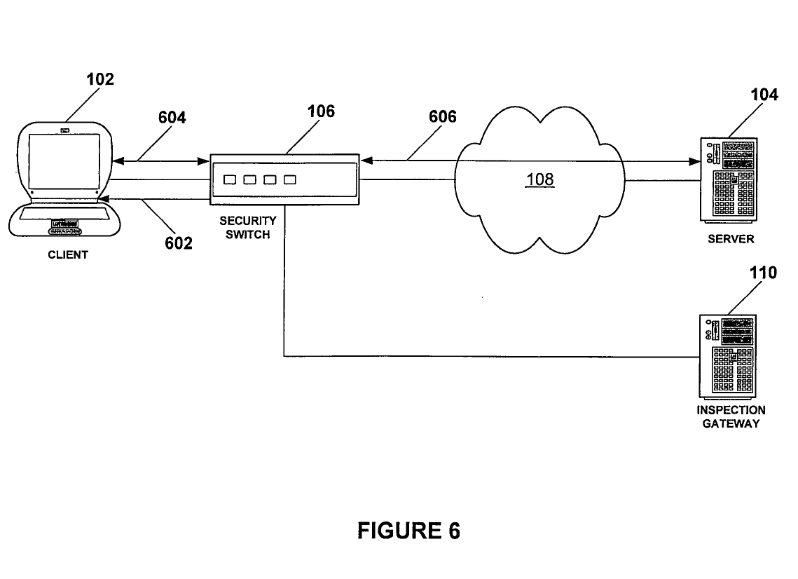

On the other hand, if the traffic proves to be “trusted” or the traffic was returned from the inspection gateway, then the security switch forwards the reply back to the client. This scenario is illustrated in FIG. 6. In step 602, the reply is forwarded to client 102, and, in step 604, the connection between security switch 106 and client 102 is closed. Similarly, in step 606, the connection between security switch 106 and server 104 is closed.

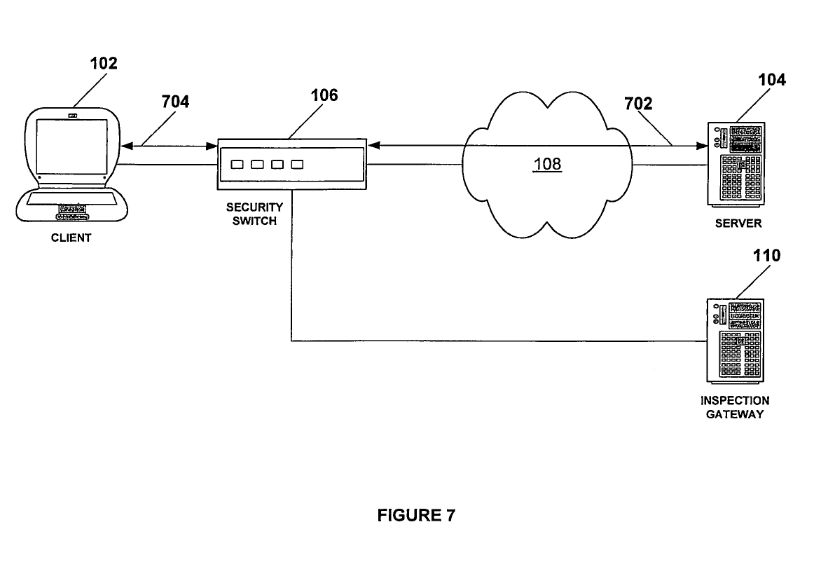

FIG. 7 illustrates a scenario wherein the reply is deemed “non-trusted”. In step 602, the connection between server 104 and security switch 106 is terminated. Similarly, in step 604, the connection between security switch 106 and client 102 is terminated.

In yet another embodiment, the abovementioned operations associated with the secure switch of the present invention are limited to a selected list of authorized clients and/or a selected list of authorized servers. Hence, a request is parsed to see if the request comes from a selected client to a selected server, prior to executing the abovementioned operations associated with the secure switch.

Furthermore, the present invention includes a computer program code based product, which is a storage medium having program code stored therein which can be used to instruct a computer to perform any of the methods associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

Implemented in computer program code based products are:

(a) computer readable program code aiding in the reception of a request from a client for establishing a communication session with a server;

(b) computer readable program code parsing and identifying a file extension associated with the received request;

(c) computer readable program code comparing the identified file extension with the pre-stored list of trusted file extensions;

(d) computer readable program code forwarding the received request to an inspection gateway;

Further implemented in computer program code based products are:

(e) when a successful match is not found when comparing the identified file extension with the pre-stored list of trusted file extensions, the computer readable program code forwards the received request to an inspection gateway

(f) when a successful match is found when comparing the following steps are executed by computer readable program code:

(1) establishing a communication session with the server and forwarding the received request to the server;

(2) receiving a reply from the server corresponding to the received request, containing an object;

(3) parsing the reply to identify a content-type of the object;

(4) comparing the identified content-type with the pre-stored list of trusted content-types; and

(5) upon finding a successful match, forwarding the reply to the client.

As pointed out above, “file extensions” have been used as the identifier to distinguish between trusted and non-trusted requests. However, other identifiers may also be in the request other than file extensions, and the use of any such identifier to determine whether the request is trusted or non-trusted is equivalent to using the “file extension” identifier. Also, other identifiers may be in the reply, and the use of such identifiers to determine whether the reply is trusted or non-trusted is equivalent to the use of the above-mentioned “Content-Type” field.

### CONCLUSION

A system and method has been shown in the above embodiments for the effective implementation of content security by a network switch. While various preferred embodiments have been shown and described, it will be understood that there is no intent to limit the invention by such disclosure but, rather, it is intended to cover all modifications falling within the spirit and scope of the invention, as defined in the appended claims. For example, the present invention should not be limited by location of the network switch, type of network between security switch and server, number of networks between security switch and server, type of inspection gateway, number of objects retrieved per request, software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of network programming.

1. A method for implementing a network security level via a security switch, said security switch storing a modifiable list of trusted file extensions, said method as implemented in said network switch comprising the steps of:
(a) receiving a request from a client to a server;
(b) parsing and identifying a file extension associated with said received request;
(c) comparing said identified file extension with said pre-stored list of trusted file extensions; and
(d) forwarding the received request to an inspection gateway a upon not finding a successful match.

2. A method as per claim 1, wherein upon finding a successful match in step (c) forwarding said received request to said server.

3. A method as per claim 1, wherein said steps (a) through (d) are performed upon verifying that said client is an authorized client.

4. A method as per claim 1, wherein said steps (a) through (d) are performed upon verifying that said server is an authorized server.

5. A method as per claim 1, wherein said security switch stores a modifiable list of trusted content-types, said method further comprising the steps of:
receiving a reply from said server;
parsing said reply to identify a content-type of an object contained in said reply;
comparing said identified content-type with said pre-stored list of trusted content-types; and
upon finding a successful match, forwarding said reply to said client.

6. A method as per claim 1, wherein said request is a HTTP request.

7. A method as per claim 1, wherein communication session between said client and said server is a TCP/IP session.

8. A method as per claim 1, wherein said object is any of the following: an image file, an audio file, a video file, an active server page file, a script file, or a markup language-based file.

9. A method as per claim 1, wherein said security switch communicates with said server over a network, and said network is any of the following: local area network (LAN), wide area network (WAN), metropolitan area network (MAN), wireless network, cellular network, or the Internet.

10. An article of manufacture comprising a computer usable medium having computer readable program code embodied therein implementing a network security level via a modifiable list of trusted file extensions, said medium comprising:
(a) computer readable program code aiding in receiving a request from a client to a server;
(b) computer readable program code parsing and identifying a file extension associated with a received request;
(c) computer readable program code comparing an identified file extension with said pre-stored list of trusted file extensions; and
(d) computer readable program code aiding in forwarding the received request to an inspection gateway.

11. A method as per claim 10, wherein the computer readable program code causes the forwarding of the received request to an inspection gateway upon not finding a successful match, and wherein upon finding a successful match, further comprising:
(1) computer readable program code forwarding a received request to a server;
(2) computer readable program code receiving a reply from a server; and
(3) computer readable program code aiding in forwarding a reply to a client.

12. An article of manufacture as per claim 10, wherein said medium further comprises:
computer readable program code parsing a reply to identify a content-type of an object contained in said reply;
computer readable program code comparing an identified content-type with a pre-stored list of trusted content-types; and
upon finding a successful match, computer readable program code forwarding said reply to said client.

13. A method for implementing a network security level via a security switch, said security switch storing a modifiable list of trusted file extensions and a modifiable list of trusted content-types, said method as implemented in said network switch comprising the steps of:
(a) receiving a request from a client to a server;
(b) parsing and identifying a file extension associated with said received request;
(c) comparing said identified file extension with said pre-stored list of trusted file extensions; and
(d) forwarding said received request to an inspection gateway upon not finding a successful match.

14. A method as per claim 13, wherein upon finding a successful match, further comprising:
(1) forwarding said received request to said server;
(2) receiving a reply from said server,
(3) parsing said reply to identify a content-type of an object contained in said reply;
(4) comparing said identified content-type with said pre-stored list of trusted content-types; and
(5) upon finding a successful match, forwarding said reply to said client.

15. A method as per claim 13, wherein said steps (a) through (d) are performed upon verifying that said client is an authorized client.

16. A method as per claim 13, wherein said steps (a) through (d) are performed upon verifying that said server is an authorized server.

17. A method as per claim 13, wherein said request is a HTTP request and a communication session between said client and said server is a TCP/IP session.

18. A method as per claim 13, wherein said object is any of the following: an image file, an audio file, a video file, an active server page file, a script file, or a markup language-based file.

19. A method as per claim 13, wherein said security switch communicates with said server over a network, and said network is any of the following: local area network (LAN), wide area network (WAN), metropolitan area network (MAN), wireless network, cellular network, or the Internet.

20. A system implementing network security for content exchanged between a client and a server over a network, said system comprising:
(a) a security switch storing a modifiable list of trusted file extensions, said security switch:
receives and parses requests to identify a file extension associated with a received request;
compares said identified file extension with said pre-stored list of trusted file extensions; and
upon finding a successful match, forwards said received request to said server and receives a reply from said server; and
(b) an inspection gateway working in conjunction with said security switch and receiving forwarded requests when a file extension of a request fails to match trusted file extensions in said pre-stored list, said inspection gateway communicating with said server and retrieving, inspecting, and verifying an object related to said received request, and based upon successful verification, forwarding a reply to said security switch.

21. A system as per claim 20, wherein said security switch further comprises a modifiable list of trusted content-types, and said security switch after reception of said reply from said server,
parses said reply to identify a content-type of an object contained in said reply;
compares said identified content-type with said pre-stored list of trusted content-types; and
upon finding a successful match, forwards said reply to said client.

22. A system as per claim 20, wherein said request is an HTTP request and communication between said client and server is via a TCP/IP session.

23. A system as per claim 20, wherein said object is any of the following: an image file, an audio file, a video file, an active server page file, a script file, or a markup language-based file.

24. A system as per claim 20, wherein said security switch communicates with said server over a network, and said network is any of the following: local area network (LAN), wide area network (WAN), metropolitan area network (MAN), wireless network, cellular network, or the Internet.

25. An article of manufacture comprising a computer usable medium having computer readable program code embodied therein implementing a network security level via a modifiable list of trusted file extensions and a modifiable list of trusted content-types, said medium comprising:
(a) computer readable program code aiding in receiving a request from a client to a server;
(b) computer readable program code parsing and identifying a file extension associated with a received request;
(c) computer readable program code comparing an identified file extension with said pre-stored list of trusted file extensions; and
(d) computer readable program code aiding in forwarding said received request to an inspection gateway upon finding a successful match,

26. The medium of claim 25 further comprising:
(1) computer readable program code aiding in forwarding a received request to a server;
(2) computer readable program code aiding receiving a reply from a server,
(3) computer readable program code parsing a reply to identify a content-type of an object contained in said reply;
(4) computer readable program code comparing an identified content-type with said pre-stored list of trusted content-types; and
(5) computer readable program code aiding in forwarding a reply to a client upon finding a successful match.

27. The medium as per claim 26, wherein when said computer readable program code compares an identified file extension with said pre-stored list of trusted file extensions and does not find a match said computer readable program code of (1) through (5) is executed.

28. A method for implementing a network security level via a security switch, said method as implemented in said network switch comprising the steps of:
(a) receiving a request from a client to a server;
(b) parsing and identifying a file extension associated with said received request;
(c) verifying said identified file extension as a trusted file extension; and
(d) upon not verifying said identified file extension, forwarding the received request to an inspection gateway; else forwarding said received request to said server.

29. A method as per claim 28, said method further comprising the steps of:
receiving a reply from said server;
parsing said reply to identify a content-type of an object contained in said reply;
verifying said identified content-type as a trusted content-type; and
upon verifying said identified content-type, forwarding said reply to said client.

30. A method as per claim 28, wherein said steps (a) through (d) are performed upon verifying that said client is an authorized client.

31. A method as per claim 28, wherein said steps (a) through (d) are performed upon verifying that said server is an authorized server.

32. A method for implementing a network security level via a security switch, said method as implemented in said network switch comprising the steps of:
(a) receiving a request from a client to a server;
(b) verifying said received request as a trusted request; and
(c) upon not verifying said received request, forwarding said received request to an inspection gateway; else forwarding said received request to said server.

33. A method as per claim 32, said method further comprising the steps of:
receiving a reply from said server;
parsing said reply to identify a type of an object contained in said reply;
verifying said identified type of object as a trusted object type; and
upon verifying said identified type of object, forwarding said reply to said client, else, not forwarding said reply to said client.

34. A method as per claim 32, wherein said steps (a) through (c) are performed upon verifying that said client is an authorized client.

35. A method as per claim 32, wherein said steps (a) through (c) are performed upon verifying that said server is an authorized server.
